(19) United States
(12) Patent Application Publication
(10) Pub. No.: US 2009/0034479 A1
(43) Pub. Date: Feb. 5, 2009

(54) Network system, control method, and gateway

(75) Inventors: Koji Wakayama, Kokubunji (JP); Hirotake Wakai, Fuchu (JP)

Correspondence Address: Stanley P. Fisher;Reed Smith LLP, Suite 1400, 3110 Fairview Park Drive, Falls Church, VA, 22042-4503, US

(73) Assignee: Hitachi Kokusai Electric Inc.

(21) Appl. No.: 12/219,258

(22) Filed: Jul. 18, 2008

(30) Foreign Application Priority Data
Jul. 31, 2007 (JP) 2007-198683

(51) Int. Cl. H04Q 7/00

(52) U.S. Cl. 370/332

(57) ABSTRACT

To prevent a packet loss during hand over, provided is a network system including: a gateway coupled with a wired network; and at least two base stations coupled with the gateway over the wired network and providing a wireless access method, in which the gateway is configured to: calculate, for each of the at least two base stations, a delay in information transmission between the gateway and each of the at least two base stations; choose a maximum delay from among the calculated delays of each of the at least two base stations; calculate, as a delay difference of each of the at least two base stations, a difference between the chosen maximum delay and the delay of each of the at least two base stations; and notify each of the at least two base stations of the calculated delay difference of each of the at least two base stations.

### CLAIM OF PRIORITY

The present application claims priority from Japanese patent application P2007-198683 filed on Jul. 31, 2007, the content of which is hereby incorporated by reference into this application.

### BACKGROUND OF THE INVENTION

This invention relates to a network system in which information is communicated between a gateway and a plurality of base stations, and more particularly, to a network system that synchronizes timing of transmitting information among a plurality of base stations.

An IEEE 802.16e standard mobile WiMAX (Worldwide Interoperability for Microwave Access) regulates Multicast and Broadcast Services (MBSs). With an MBS regulated by IEEE 802.16e, one can provide a broadcast service through wireless access. IEEE 802.16e recommends synchronizing the timing of transmitting packets to subscriber stations among base stations in an MBS. However, exactly what algorithm is to be employed to synchronize the transmission timing is not standardized.

A gateway coupled over a network with a server that provides information sends packets of the information provided by the server to a plurality of base stations concurrently through multicast route. The packets sent out simultaneously by the gateway do not arrive at the base stations at the same time because the packets take different transmission paths leading to the respective base stations.

In multicast communication, subscriber stations that are stationary have no problems with packets arriving at different times from one another. On the other hand, in the case of subscriber stations that move as in mobile communication, specifically, when a subscriber station that is covered by one base station moves from an area in which the subscriber station can access the base station by radio (hereinafter, referred to as cell) to a cell that is covered by another base station, the subscriber station can miss some of sent packets unless the packet transmission timing is synchronized between the base stations.

A communication where the packet size is 1500 bytes and the communication speed is 10 Mbit/s is taken as an example. A base station in this case requires 1.2 milliseconds to send one packet.

When a subscriber station crosses the border between a cell covered by one base station and a cell covered by another base station, thereby causing hand over from the cell in which the subscriber station has been receiving packets to the other cell, the difference in transmission timing between the pre-hand over base station and the post-hand over base station has to be within 1.2 milliseconds in order that the same packet that the subscriber station has been receiving prior to the hand over can be received from the other base station.

3GPP TS25.402 V5. 1.0 “Synchronization in UTRAN: Stage 2” (June 2002) regulates a method in which a radio Network controller controls the transmission timing of base stations by measuring a delay in packet communication between the radio controller and each base station. However, too large a difference in transmission timing among base stations in multicast communication causes a problem in that information is not easily passed over during hand over between cells in which a subscriber station receives packets.

JP 2005-210698 A discloses a solution to this problem in which the transmission timing is determined by setting synchronization precision specific to each controller that controls a cell. The synchronization precision include a cycle of performing transmission timing synchronization processing and a system of transmission timing synchronization processing.

However, the technology described in JP 2005-210698 A does not take into consideration concrete differences in delay among different paths from radio controllers to base stations.

### SUMMARY OF THE INVENTION

It is therefore an object of this invention to synchronize the packet transmission timing among base stations in multicast communication over a wireless access network based on differences in packet propagation delay between a gateway and the base stations.

According to one embodiment of the invention, there is therefore provided a network system, comprising: a gateway coupled with a wired network; and at least two base stations coupled with the gateway over the wired network to communicate information between the gateway and each of the at least two base stations, the at least two base stations providing a wireless access method, wherein the gateway is configured to: calculate, for each of the at least two base stations, a delay in information transmission between the gateway and each of the at least two base stations; choose a maximum delay from among the calculated delays of each of the at least two base stations; calculate, for each of the at least two base stations, a difference between the chosen maximum delay and the delay of each of the at least two base stations; and notify each of the at least two base stations of the calculated delay difference of each of the at least two base stations.

According to an aspect of this invention, a packet loss can be prevented during hand over between base stations from which a subscriber station receives packets.

### BRIEF DESCRIPTION OF THE DRAWINGS

The present invention can be appreciated by the description which follows in conjunction with the following figures, wherein:

FIG. 1A is a diagram showing a configuration of a network system according to an embodiment of this invention;

FIG. 1B is a diagram illustrating multicast communication over an access network according to the embodiment of this invention;

FIG. 2 is a block diagram showing a configuration of a gateway according to the embodiment of this invention;

FIG. 3 is a block diagram showing a configuration of the control processor which is provided in the gateway according to the embodiment of this invention;

FIG. 4 is a block diagram showing a configuration of a line interface which are provided in the gateway according to the embodiment of this invention;

FIG. 5 is a block diagram showing a configuration of base stations according to the embodiment of this invention;

FIG. 6 is a block diagram showing a configuration of an access network line interface which is provided in each base station according to the embodiment of this invention;

FIG. 7 is a block diagram showing a configuration of a delay circuit which is provided in the access network line interface according to the embodiment of this invention;

FIG. 8 is a diagram illustrating a multicast table according to the embodiment of this invention;

FIG. 9 is a block diagram showing a configuration of a control processor which is provided in each base station according to the embodiment of this invention;

FIG. 10 is a diagram illustrating a control packet according to the embodiment of this invention;

FIG. 11 is a sequence diagram of control packets for processing of measuring a delay according to the embodiment of this invention;

FIG. 12 is a diagram illustrating a delay table which is stored in the gateway according to the embodiment of this invention;

FIG. 13 is a flowchart for processing that is executed when the gateway receives control packets from the base stations according to the embodiment of this invention;

FIG. 14 is a flowchart for processing of determining a maximum delay according to the embodiment of this invention; and

FIG. 15 is a flowchart illustrating an operation of the delay circuit according to the embodiment of this invention.

### DETAILED DESCRIPTION OF THE PREFERRED EMBODIMENT

An embodiment of this invention will be described below with reference to the accompanying drawings.

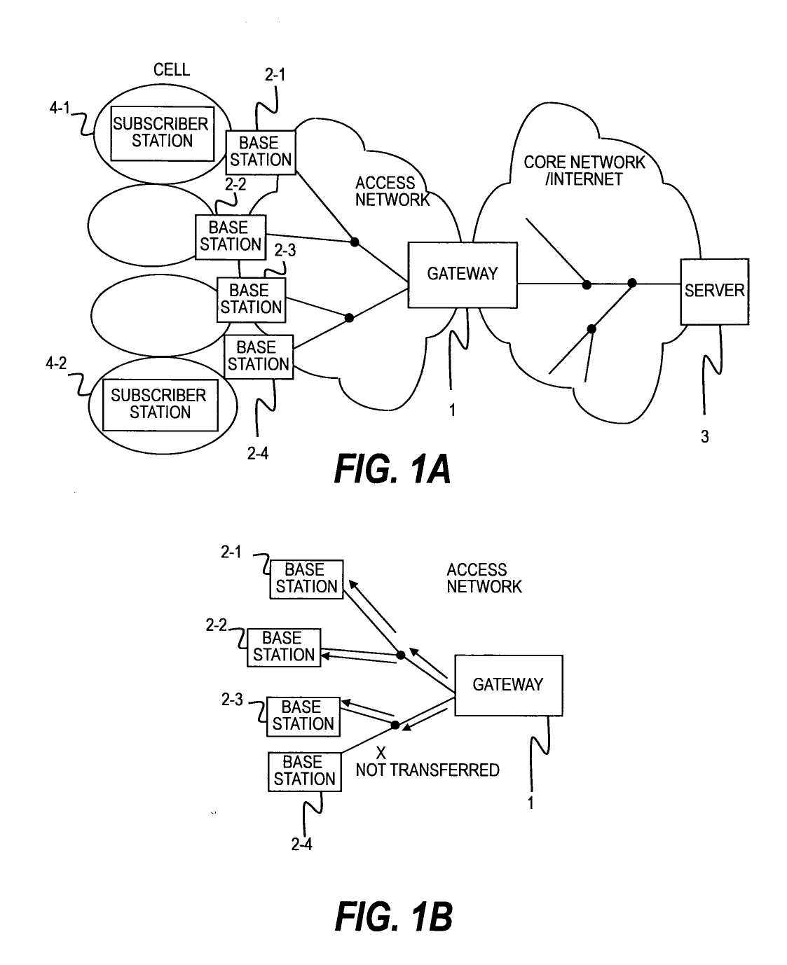

FIG. 1A is a diagram showing a configuration of a network system according to the embodiment of this invention.

The network system of this embodiment has a gateway 1, base stations 2, a server 3, and subscriber stations 4.

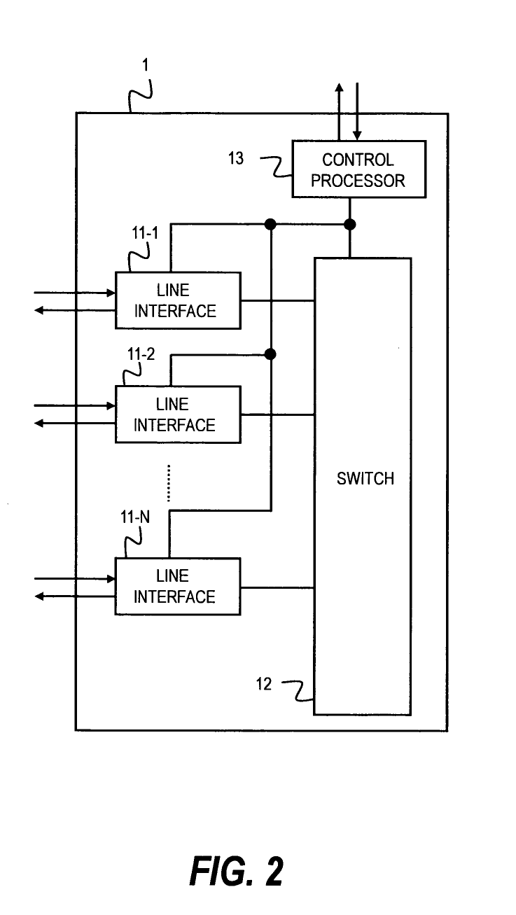

The gateway 1 couples a core network or the Internet and an access network built by the base stations 2. Details of the gateway 1 will be described with reference to FIGS. 2 to 4.

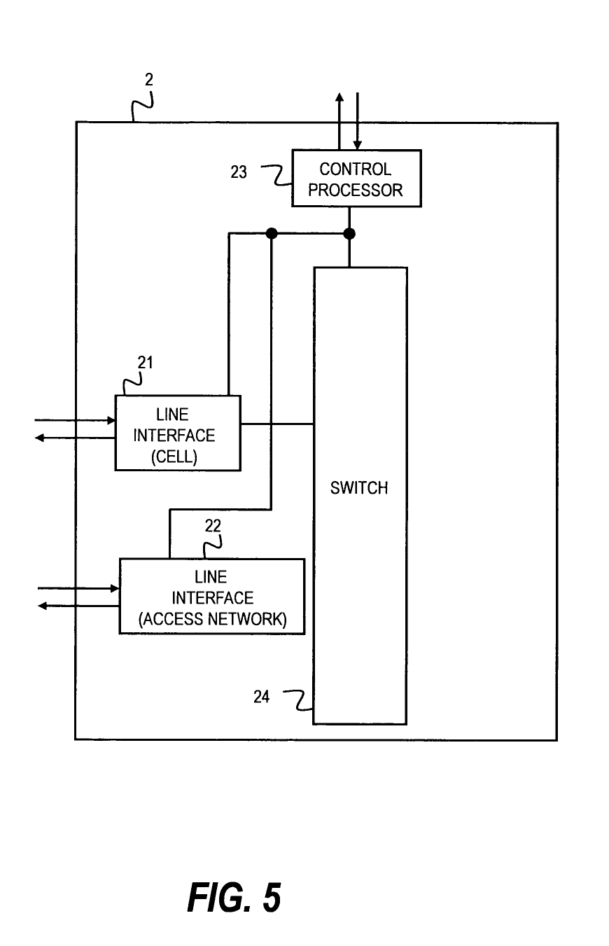

The base stations 2 provide a wireless access method for enabling the subscriber stations 4 to access by radio. Details of the base stations 2 will be described with reference to FIGS. 5 to 9.

The server 3 provides the subscriber stations 4 with information through streaming, World Wide Web (WWW), and the like.

The subscriber stations 4, when located in cells which are areas within wireless access, can couple with the base stations 2 to receive packets of information provided by the server 3.

FIG. 1B is a diagram illustrating multicast communication over an access network according to the embodiment of this invention.

The gateway 1 sends packets only to the base stations 2-1, 2-2, and 2-3 out of the base stations 2-1, 2-2, 2-3, and 2-4.

In this case, the same multicast address is set to the base stations 2-1, 2-2, and 2-3.

The server 3 sends to the gateway 1 packets of information to be provided to the subscriber stations 4. The packets sent by the server 3 contain multicast addresses.

Receiving the packets from the server 3, the gateway 1 copies the received packets and transfers the packet copies to the base stations 2-1, 2-2, and 2-3.

The base stations 2-1, 2-2, and 2-3 receive the transferred packets. The gateway 1 does not transfer the packets to the base station 2-4 because no multicast address is set to the base station 2-4.

FIG. 2 is a block diagram showing a configuration of the gateway 1 according to the embodiment of this invention.

The gateway 1 has line interfaces 11, a switch 12, and a control processor 13.

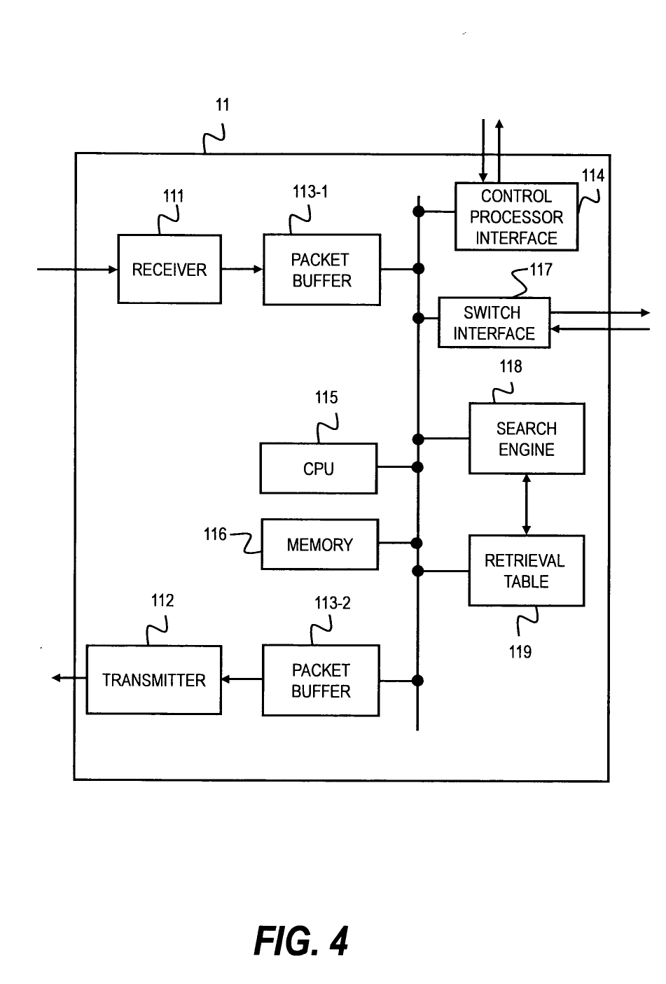

The line interfaces 11 are physical interfaces that couple the access network with the core network or the Internet. The line interfaces 11 determine to which line interface 11 a packet received by one line interface 11 is to be transferred. Details of the line interfaces 11 will be described with reference to FIG. 4.

The switch 12 determines a transfer path leading to the line interface 11 that is determined as a transfer destination.

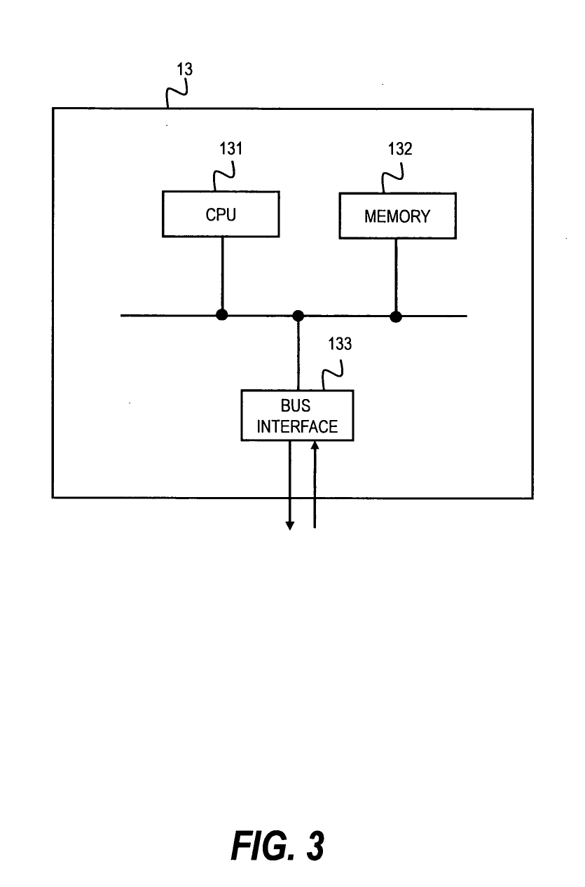

The control processor 13 performs overall control of the gateway 1 and executes processing on the control plane. Details of the control processor 13 will be described with reference to FIG. 3.

FIG. 3 is a block diagram showing a configuration of the control processor 13 which is provided in the gateway 1 according to the embodiment of this invention.

The control processor 13 has a CPU 131, a memory 132, and a bus interface (I/F) 133.

The CPU 131 executes various programs stored in the memory 132. The memory 132 stores various programs. The bus I/F 133 is an interface that couples the control processor 13 with the switch 12 and the line interfaces 11.

FIG. 4 is a block diagram showing a configuration of the line interfaces 11 which are provided in the gateway 1 according to the embodiment of this invention.

Each line interface 11 has a receiver 111, a transmitter 112, packet buffers 113, a control processor interface (I/F) 114, a CPU 115, a memory 116, a switch interface (I/F) 117, a search engine 118, and a retrieval table 119.

The receiver 111 executes packet reception processing. Specifically, the receiver 111 terminates a physical layer and a datalink layer of a received packet. The transmitter 112 executes packet transmission processing. Specifically, the transmitter 112 terminates the physical layer and the datalink layer of a packet to be sent out.

The packet buffers 113 temporarily store received packets or packets to be sent out.

The control processor I/F 114 is an interface that couples the line interface 11 with the control processor 13.

The CPU 115 executes various programs stored in the memory 116 to execute processing of setting the retrieval table 119 and processing of controlling the line interface 11. The memory 116 stores various programs.

The switch I/F 117 is an interface that couples the line interface 11 with the switch 12.

The retrieval table 119 is a table for registering addresses to which packets are transferred. The search engine 118 refers to the retrieval table 119 to obtain information about the transfer destination of a packet.

FIG. 5 is a block diagram showing a configuration of the base stations 2 according to the embodiment of this invention.

Each base station 2 has a wireless access line interface 21, a wired access network line interface 22, a control processor 23, and a switch 24.

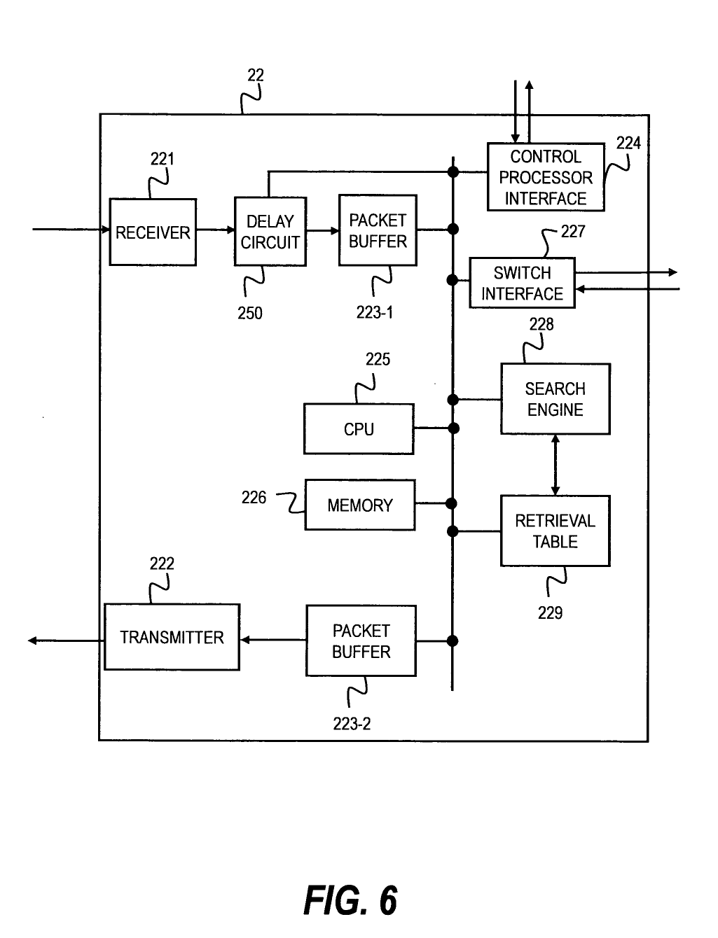

The wireless access line interface 21 is a physical interface that enables the base station 2 to provide the subscriber stations 4 with a wireless access method. The access network line interface 22 is a physical interface that couples the base station 2 with the access network. The wireless access line interface 21 determines to which line interface 11 a packet received by one line interface 11 is to be transferred. Details of the access network line interface 22 will be described with reference to FIG. 6. A detailed description will be omitted on the wireless access line interface 21, which has the same configuration as that of the line interface 11 of the gateway 1 shown in FIG. 4. The transmitter in the wireless access line interface 21, however, executes processing of sending a packet to a wireless interface.

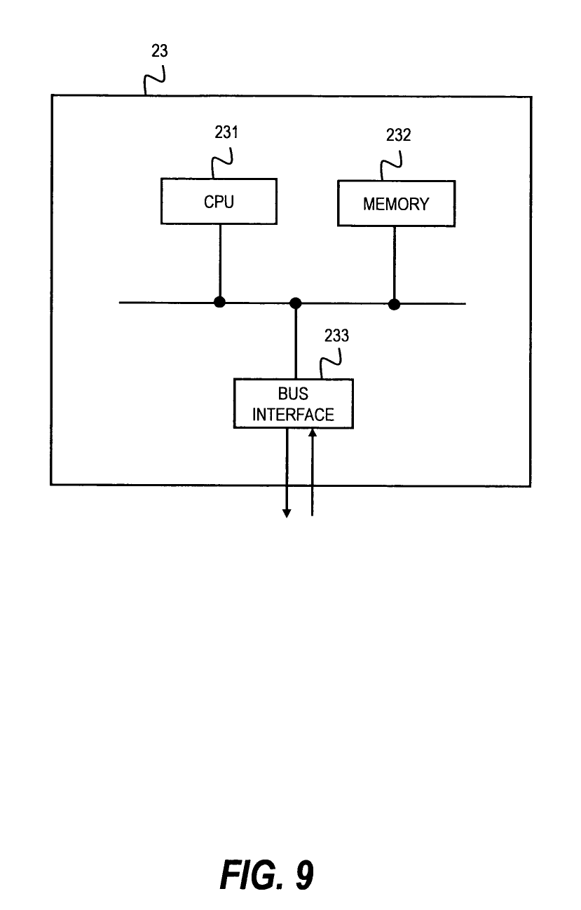

The control processor 23 takes charge of overall control of the base station 2 and executes processing on the control plane. Details of the control processor 23 will be described with reference to FIG. 9.

The switch 24 executes processing of transferring a packet between line interfaces.

FIG. 6 is a block diagram showing a configuration of the access network line interface 22 which is provided in each base station 2 according to the embodiment of this invention.

The access network line interface 22 has a receiver 221, a transmitter 222, packet buffers 223, a control processor interface (I/F) 224, a CPU 225, a memory 226, a switch interface (I/F) 227, a search engine 228, a retrieval table 229, and a delay circuit 250.

The components of the access network line interface 22 are the same as those in the line interface 11 of the gateway 1 shown in FIG. 4, except for the delay circuit 250. Descriptions on the components common to the access network line interface 22 and the line interface 11 will be omitted here.

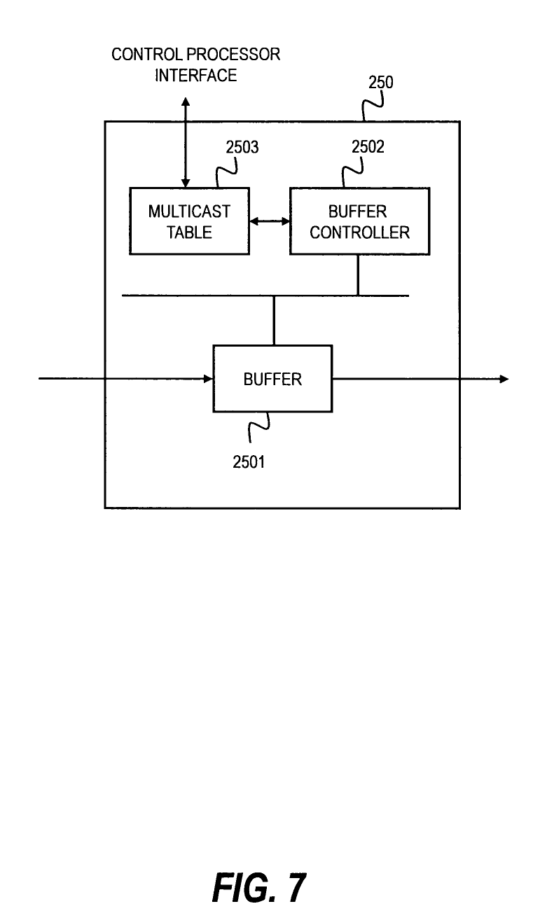

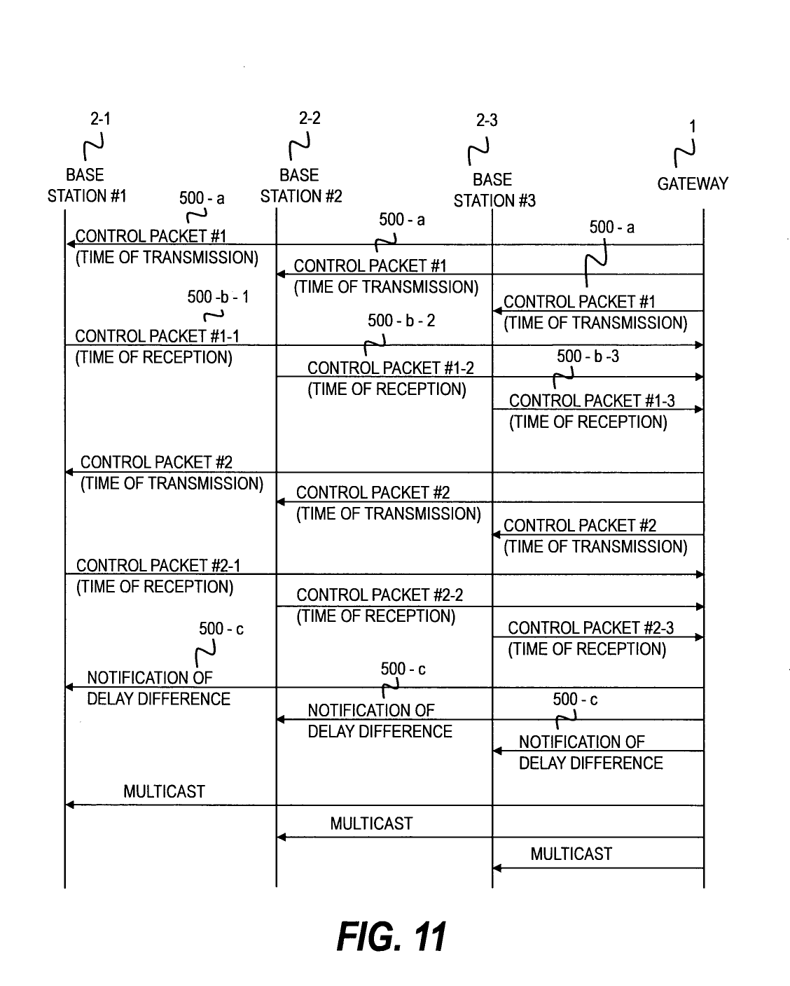

The delay circuit 250 is coupled between the receiver 221 and the packet buffers 223. The delay circuit 250 delays the transmission of a received packet by a period of time equivalent to a delay difference, which is notified from the gateway 1. The delay difference is calculated by the gateway 1. Details of the delay difference will be described with reference to FIG. 11. Details of the delay circuit 250 will be described with reference to FIG. 7.

FIG. 7 is a block diagram showing a configuration of the delay circuit 250 which is provided in the access network line interface 22 according to the embodiment of this invention.

The delay circuit 250 has a buffer 2501, a buffer controller 2502, and a multicast table 2503.

The buffer 2501 is logically partitioned into sections each of which is associated with a multicast address. A packet received by the delay circuit 250 is temporarily stored in a section of the buffer 2501 that is associated with the multicast address of the received packet.

The buffer controller 2502 refers to the multicast table 2503 to determine how long a received packet is to be stored in the buffer 2501.

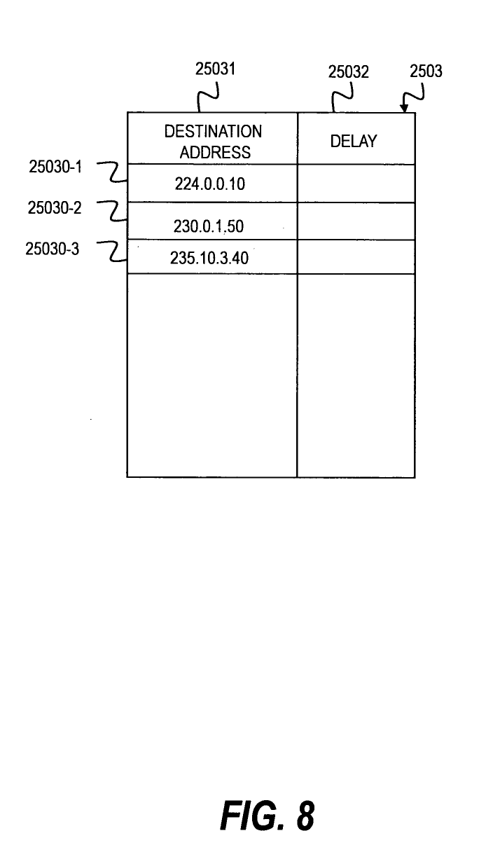

The multicast table 2503 is a table used to manage the delay difference for each multicast address. Details of the multicast table 2503 will be described with reference to FIG. 8.

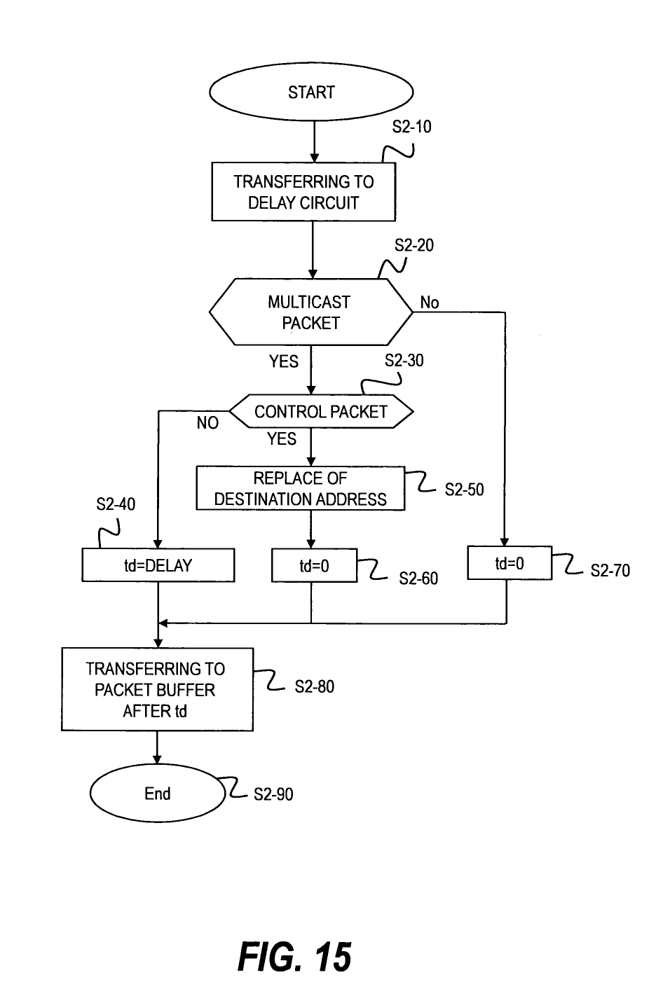

An operation of the delay circuit 250 will be described in detail with reference to FIG. 15.

FIG. 8 is a diagram illustrating the multicast table 2503 according to the embodiment of this invention.

The multicast table 2503 contains in each entry a destination address 25031 and a delay 25032.

A multicast address to which a packet received by the base station 2 is to be transferred is registered as the destination address 25031. A delay for adjusting the timing of transmitting a packet to a multicast address that is registered as the destination address 25031 among the base stations 2 is registered as the delay 25032.

FIG. 9 is a block diagram showing a configuration of the control processor 23 which is provided in each base station 2 according to the embodiment of this invention.

The control processor 23 has a CPU 231, a memory 232, and a bus interface (I/F) 233.

The CPU 231 executes various programs stored in the memory 232. The memory 232 stores various programs. The bus I/F 233 is a physical interface that couples the control processor 23 with the cell line interface 21 (wireless access line interface), the access network line interface 22, and the switch 24.

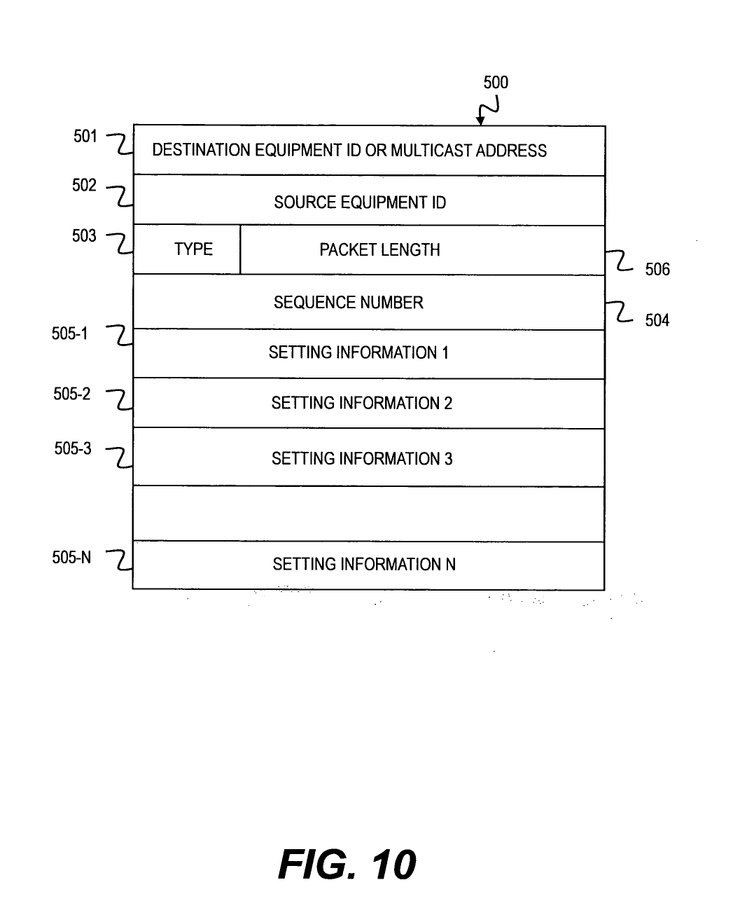

FIG. 10 is a diagram illustrating a control packet 500 according to the embodiment of this invention.

The control packet 500 contains a destination equipment ID 501, a source equipment ID 502, a type 503, a sequence number 504, setting information 505, and a packet length 506.

An identifier of equipment to which the packet is sent is registered as the destination equipment ID 501.A multicast address or an identifier of equipment which sends the packet is registered as the source equipment ID 502.

An identifier indicating the type of the control packet 500 is registered as the type 503. The types of the control packet 500 include delay measurement request, delay measurement response, delay difference notification, and others. An identifier that indicates an order of the control packet 500 is registered as the sequence number 504.

Setting information of the control packet 500 of various kinds is registered as the setting information 505. In the case where the control packet 500 is a delay measurement request packet, the time when the gateway 1 transmits this control packet 500 is registered as the setting information 505.

A data size of the control packet 500 may have a variable length. For example, giving the control packet 500 the same data size as that of a packet that is actually sent by the server 3 makes it possible to measure a delay resembling one in a traffic of actual transmission from the server 3. The data size of the control packet 500 is registered as the packet length 506.

The control packet 500 may be sent as an Internet Protocol (IP) packet or as an IEEE 802.3 frame.

FIG. 11 is a sequence diagram of control packets for processing of measuring a delay according to the embodiment of this invention.

First, the gateway 1 sends a control packet 500-a, in which the time of transmission of the control packet 500-a is set, to the base stations 2-1, 2-2, and 2-3 by multicast. The base stations 2-1, 2-2, and 2-3 are base stations to which packets sent from the server 3 are transferred through multicast route.

In the control packet 500-a, a multicast address that identifies a multicast group consisting of the base stations 2-1, 2-2, and 2-3 is registered as the destination equipment ID 501.

As the source equipment ID 502, an identifier of the gateway 1 which has sent the control packet 500-a is registered. An identifier indicating that this control packet 500-a is a packet that requests a delay measurement is registered as the type 503. A sequence number assigned to the control packet 500-a is registered as the sequence number 504. A time at which the gateway 1 has sent the control packet 500-a is registered as the setting information 505-1.

The control packet 500-a is created by the control processor 13 in the gateway 1.

Receiving the control packet 500-a from the gateway 1, each of the base stations 2-1, 2-2, and 2-3 sends a control packet 500-b in which the time of reception of the control packet 500-a is set to the gateway 1.

In each control packet 500-b, the identifier of the gateway 1 which has been registered as the source equipment ID 502 in the received control packet 500-a is registered as the destination equipment ID 501. An identifier of the base station 2 which has been registered as the destination equipment ID 501 in the received control packet 500-a is registered as the source equipment ID 502.

An identifier indicating that this control packet 500-b is a packet that is a response to the delay measurement request is registered as the type 503. The time of transmission of the control packet 500-a from the gateway 1 is registered as the setting information 505-1 and the time of reception of the control packet 505-a by the base station 2 is registered as the setting information 505-2.

The control packet 500-b is created by the control processor 13 in the gateway 1 or the control processor 23 in the base station 2.

The gateway 1 and the base station 2 repeat the transmission and reception of the control packets a given number of times in the manner described above.

Next, the gateway 1 calculates how long it takes for the control packet sent from the gateway 1 to be received by the respective base stations 2 (delay).

Specifically, the gateway 1 refers to the received control packets 500-b to calculate the difference between the time of transmission of the control packet 500-a from the gateway 1 and the time when each base station 2 has received the control packet 500-a sent from the gateway 1.

The gateway 1 then calculates an average delay for each base station 2.

The control packet 500-a sent from the gateway 1 is created by the control processor 13 in the gateway 1. The difference between the time of transmission of the control packet 500-a from the gateway 1 and the time when each base station 2 has received the control packet 500-a sent from the gateway 1 includes the period of time which it takes for the access network line interface 22 of the base station 2 to complete the processing of receiving the control packet 500-a and the period of time required for processing of an upper layer such as the IP layer that is involved in processing of transferring data from the access network line interface 22 to the control processor 23.

The gateway 1 then determines which base station 2 has the largest average delay value (maximum delay) among the base stations 2 for which an average delay has been calculated.

The gateway 1 next calculates, for each base station 2, the difference between the determined maximum delay and the average delay of the base stations 2 (delay difference).

The gateway 1 notifies each base station 2 of the calculated delay difference by sending a control packet 500-c to the base station 2.

In the control packet 500-c, identifiers registered as the destination equipment ID 501 and the source equipment ID 502 are the same as the identifiers registered as the destination equipment ID 501 and the source equipment ID 502 in the control packet 500-a sent from the gateway 1. Their descriptions therefor will not be repeated.

An identifier indicating that this control packet 500-c is a notification of a delay difference is registered as the type 503. A delay difference in transmission of a control packet is registered as the setting information 505-1.

Thereafter, the gateway 1 starts multicast data communication.

The control packet 500-a, which is sent from the gateway 1 to the base stations 2-1, 2-2, and 2-3 through multicast route, may be also sent through unicast route instead. In this case, the identifier of the base station 2 to which the control packet 500-a is sent is registered as the destination equipment ID 501.

When the gateway 1 transmits a control packet transferred through multicast route, the control packet takes the same path within the access network as that of a packet of information distributed by the server 3 and transferred through multicast route, which makes the precision of delay measurement even higher. The count of control packets sent from the gateway 1 in this case matches the count of multicast addresses of information packets distributed by the server 3.

When the gateway 1 transmits a control packet by unicast, the delay is determined solely by the transmission distance of the control packet. The count of destinations of a control packet sent from the gateway 1 in this case matches the count of the base stations 2.

The following description is about when to execute the delay measurement with control packets.

The delay measurement using control packets may be executed before multicast communication is started. The delay measurement using control packets may be executed also when multicast communication paths are changed, in other words, when the count of the base stations 2 that participate in multicast communication increases or decreases. Also, the delay measurement using control packets may be executed at regular intervals during multicast communication.

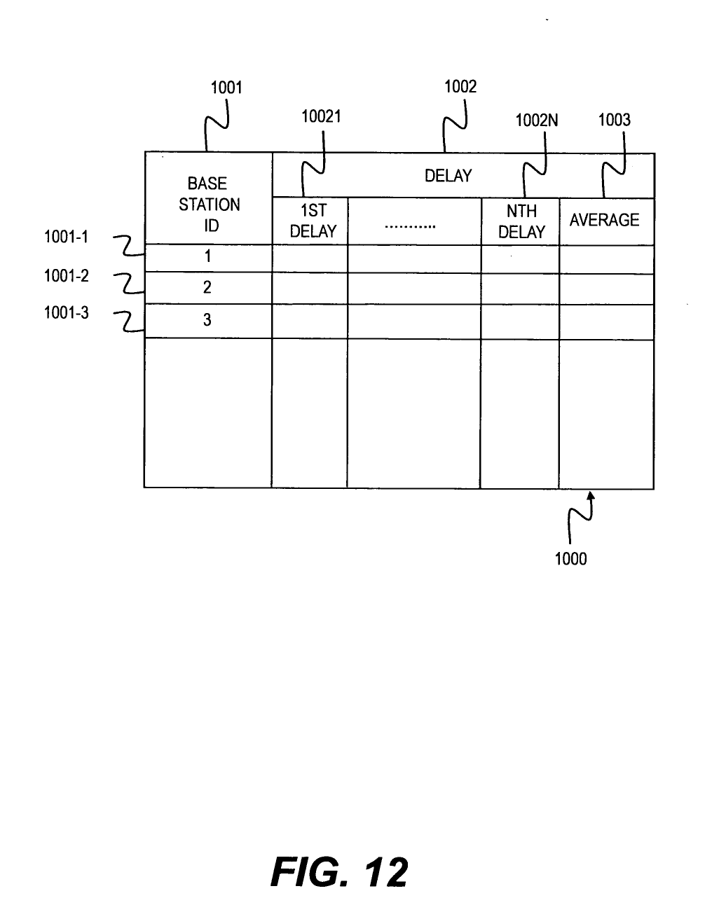

FIG. 12 is a diagram illustrating a delay table 1000 which is stored in the gateway 1 according to the embodiment of this invention.

The delay table 1000 is stored in the memory 132 which is provided in the control processor 13.

The delay table 1000 contains in each entry a base station ID 1001 and a delay 1002. The delay 1002 contains the value in the first delay measurement 10021 to the value in the N-th delay measurement 1002N and the average value 1003.

The identifier of each base station 2 is registered as the base station ID 1001. A delay calculated from the first delay measurement is registered as the first delay 10021. A delay calculated from the n-th delay measurement is registered as the N-th delay 1002N. An average delay which is obtained by averaging the first to N-th delays is registered as the average 1003.

In the case where a delay measurement request packet is transmitted by unicast, one delay table 1000 is created in the control processor 13.

On the other hand, in the case where a delay measurement request packet is transferred through multicast route as is the case for the control packet 500-a requesting a delay measurement, as many delay tables 1000 as the count of multicast addresses are created in the control processor 13. This is because different multicast addresses mean different destination base stations 2 and different paths within the access network and, even when the destination base station 2 is the same, a control packet could be transferred from the gateway 1 to the base station 2 with different delays.

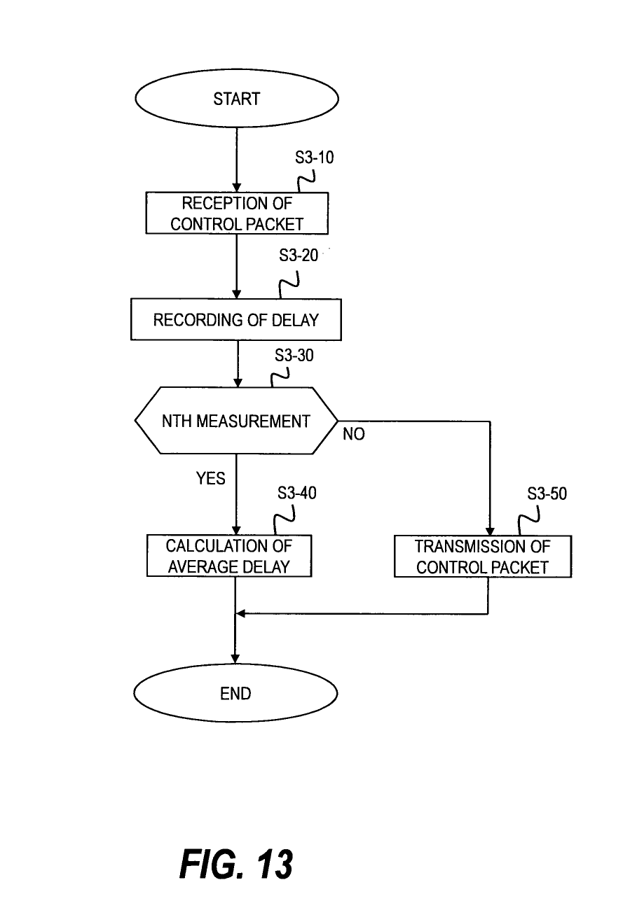

FIG. 13 is a flowchart for processing that is executed when the gateway 1 receives control packets from the base stations 2 according to the embodiment of this invention.

Receiving a control packet from one base station 2 (S3-10), the gateway 1 first calculates the delay by calculating the difference between the time of reception which is registered by the base station 2 as the setting information 505-2 in the control packet and the time of transmission which is registered by the gateway 1 as the setting information 505-1 in the control packet. The gateway 1 registers the calculated delay in the delay table 1000 as one of the delays 10021 to 1002N that corresponds to the number of times of the calculated delay (S3-20).

The gateway 1 next judges whether or not as many control packets as necessary to calculate an average delay (in this embodiment, N control packets) have been received from the base station 2 (S3-30).

When it is judged that the N-th control packet has been received, the gateway 1 calculates for each base station 2 an average of the first to N-th delays (S3-40), registers the calculated average as the average 1003 in an entry for the base station 2 in question, and ends the processing.

When it is judged that the N-th control packet has not been received, the gateway 1 sends a control packet that requests a delay measurement to the base station 2 (S3-50), and ends the processing.

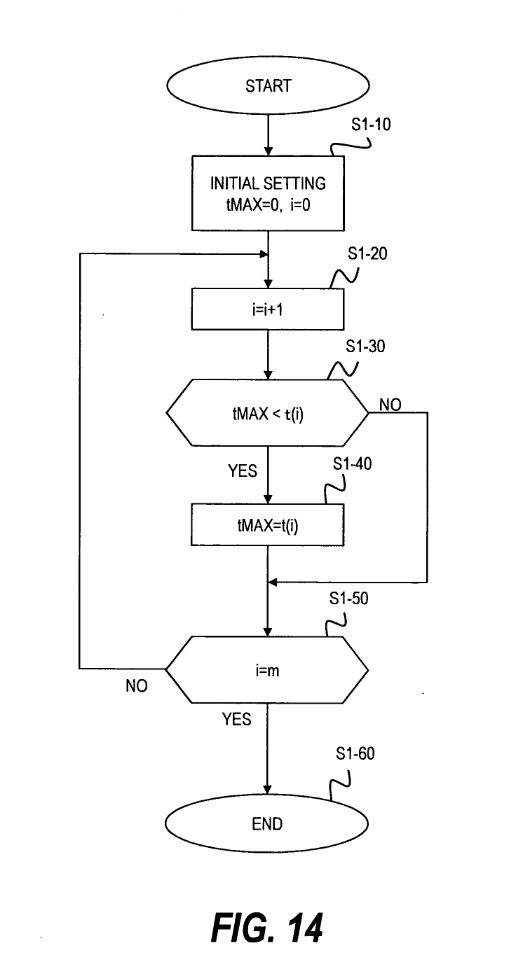

FIG. 14 is a flowchart for processing of determining the maximum delay according to the embodiment of this invention.

First, the gateway 1 executes initial setting processing (S1-10). Specifically, the gateway 1 sets the value of tMAX, which indicates the maximum delay, to 0 and the value of i, which indicates a base station, to 0.

Next, the gateway 1 adds 1 to i (S1-20). The gateway 1 judges whether or not an average delay (t(i)) of a base station that is identified by i to which 1 is added in S1-20 is equal to or larger than tMAX (S1-30).

When it is judged that t(i) is equal to or larger than tMAX, the gateway 1 updates the value of tMAX with the value of t(i) (S1-40). When it is judged that t(i) is smaller than tMAX, on the other hand, the gateway 1 proceeds to S1-50.

The gateway 1 judges whether or not the value of i matches the count of the base stations 2 (S1-50).

When it is judged that the value of i matches the count of the base stations 2, the gateway 1 ends the processing (S1-60). When it is judged that the value of i does not match the count of the base stations 2, the gateway 1 returns to S1-20.

FIG. 15 is a flowchart illustrating the operation of the delay circuit 250 according to the embodiment of this invention.

The description given here takes as an example a case in which multicast communication is conducted with the use of IPv4 and a control packet is transferred from the gateway 1 through multicast route.

First, a packet received by the receiver 221 in the access network line interface 22 is transferred to the delay circuit 250 (S2-10).

Receiving the packet from the receiver 221, the delay circuit 250 judges whether or not the received packet is a packet transferred through multicast route(S2-20).

Specifically, the delay circuit 250 judges whether or not the first four most significant bits of a destination address (IPv4) set in the packet header of the received packet is “1110”. In the case where the first four most significant bits of the destination address is not “1110”, the packet is transferred through unicast route.

When it is judged that the received packet is not a packet transferred through multicast route, the received packet is a packet transferred through unicast route and there is no need to take a delay into consideration. Then the delay circuit 250 sets a delay td to 0 (S2-70) and proceeds to S2-80.

When it is judged that the received packet is a packet transferred through multicast route, the delay circuit 250 refers to the type 503 of the received packet to judge whether or not the received packet is a control packet (S2-30).

When it is judged that the received packet is a control packet, the delay circuit 250 replaces the destination address with the identifier of the base station 2 in order to make the base station 2 terminate the received control packet (S2-50). The delay circuit 250 then sets the delay td to 0 (S2-60) and proceeds to S2-80.

When it is judged that the received packet is not a control packet, the delay circuit 250 searches the multicast table 2503 for an entry whose destination address 25031 matches the destination address of the received packet, and reads a value registered as the delay 25032 of this entry. The delay circuit 250 sets the read value to the delay td of the received packet (S2-40).

The delay circuit 250 sends the received packet to the packet buffer 223-1 with the set delay td (S2-80), and ends the processing (S2-90).

Through the above processing, the packet transmission timing can be controlled among the base stations 2 based on differences in delay in packet transmission from the gateway 1 to the base stations 2.

This embodiment has described a case in which a control packet with the time of transmission set by the gateway 1 is sent to the base stations 2 and a control packet with the time of reception of the former control packet set by each base station 2 is sent to the gateway 1. This invention can be carried out also by the following method.

A control packet with the time of transmission set by each base station 2 is sent to the gateway 1. The gateway 1 receives the control packet and calculates the delay from the difference between the time of transmission set in the received control packet and the time of reception of the control packet by the gateway 1. The gateway 1 then calculates a delay difference in the manner described in the embodiment of this invention.

The timing of transmitting multicast packets from base stations can thus be synchronized among the base stations despite differences in delay with which the base stations receive a packet from a gateway. A packet loss is accordingly prevented during hand over between base stations from which a subscriber station receives packets.

While the present invention has been described in detail and pictorially in the accompanying drawings, the present invention is not limited to such detail but covers various obvious modifications and equivalent arrangements, which fall within the purview of the appended claims.

What is claimed is:

1. A network system, comprising:
a gateway coupled with a wired network; and
at least two base stations coupled with the gateway over the wired network to communicate information between the gateway and each of the at least two base stations, the at least two base stations providing a wireless access method, wherein the gateway is configured to:
calculate, for each of the at least two base stations, a delay in information transmission between the gateway and each of the at least two base stations;
choose a maximum delay from among the calculated delays of each of the at least two base stations;
calculate, for each of the at least two base stations, a difference between the chosen maximum delay and the delay of each of the at least two base stations; and
notify each of the at least two base stations of the calculated delay difference of each of the at least two base stations.

2. The network system according to claim 1, further comprising a subscriber station which can be coupled through the wireless access method, wherein each of the at least two base stations is configured to:
communicate with the gateway through multicast route; and
transmit the information communicated through the multicast route and received from the gateway to the subscriber station with a delay determined based on the notified delay difference.

3. The network system according to claim 1, wherein:
the gateway transmits to each of the at least two base stations a first control packet including a time of transmission at which the first control packet is transmitted from the gateway;
each of the at least two base stations transmits, upon reception of the first control packet, a second control packet to the gateway, the second control packet including the time of transmission which is included in the first control packet and a time of reception at which the first control packet is received by each of the at least two base stations; and
the gateway calculates, upon reception of the second control packet, a difference between the time of reception and the time of transmission which are included in the second control packet, to thereby calculate a delay in information transmission between the gateway and each of the at least two base stations.

4. The network system according to claim 3, wherein the gateway transmits the first control packet to each of the at least two base stations through multicast route.

5. The network system according to claim 3, wherein the gateway transmits the first control packet to each of the at least two base stations through unicast route.

6. The network system according to claim 1, wherein:
each of the at least two base stations transmits to the gateway a control packet including a time of transmission at which the control packet is transmitted from each of the at least two base stations; and
the gateway calculates, upon reception of the control packet, a difference between the time of transmission which is included in the control packet and a time of reception of the control packet, to thereby calculate a delay in information transmission between the gateway and each of the at least two base stations.

7. A control method of controlling information transmission timing among at least two base stations in a network system including a gateway coupled with a wired network and the at least two base stations coupled with the gateway over the wired network to communicate information between the gateway and each of the at least two base stations, the at least two base stations providing a wireless access method, the control method comprising:
calculating, by the gateway, for each of the at least two base stations, a delay in information transmission between the gateway and each of the at least two base stations;
choosing, by the gateway, a maximum delay from among the calculated delays of each of the at least two base stations;
calculating, by the gateway, for each of the at least two base stations, a difference between the chosen maximum delay and the delay of each of the at least two base stations; and
notifying, by the gateway, each of the at least two base stations of the calculated delay difference of each of the at least two base stations.

8. The control method according to claim 7, wherein:
the network system further comprises a subscriber station which can be coupled through the wireless access method; and
the control method further comprises:
communicating, between each of the at least two base stations and the gateway through multicast route; and
transmitting, by each of the at least two base stations, the information communicated through the multicast route and received from the gateway to the subscriber station with a delay determined based on the notified delay difference.

9. The control method according to claim 7, further comprising:
transmitting, by the gateway, to each of the at least two base stations a first control packet including a time of transmission at which the first control packet is transmitted from the gateway;
transmitting, by each of the at least two base stations, upon reception of the first control packet, a second control packet to the gateway, the second control packet including the time of transmission which is included in the first control packet and a time of reception at which the first control packet is received by each of the at least two base stations; and
calculating, by the gateway, upon reception of the second control packet, a difference between the time of reception and the time of transmission which are included in the second control packet, to thereby calculate a delay in information transmission between the gateway and each of the at least two base stations.

10. The control method according to claim 9, further comprising transmitting, by the gateway, the first control packet, transferred through multicast route, to each of the at least two base stations.

11. The control method according to claim 9, further comprising transmitting, by the gateway, the first control packet, transferred through unicast route, to each of the at least two base stations.

12. The control method according to claim 7, further comprising:
transmitting, by each of the at least two base stations, to the gateway a control packet including a time of transmission at which the control packet is transmitted from each of the at least two base stations; and
calculating, by the gateway, upon reception of the control packet, a difference between the time of transmission which is included in the control packet and a time of reception of the control packet, to thereby calculate a delay in information transmission between the gateway and each of the at least two base stations.

13. A gateway that is coupled over a wired network with at least two base stations for providing a wireless access method and communicates with the at least two base stations, comprising:
a processor which performs computing;
a memory coupled with the processor; and
a network interface coupled with the wired network, wherein the processor is configured to:
calculate, for each of the at least two base stations, a delay in information transmission between the gateway and each of the at least two base stations;
choose a maximum delay from among the calculated delays of each of the at least two base stations;
calculate, for each of the at least two base stations, a difference between the chosen maximum delay and the delay of each of the at least two base stations; and
notify each of the at least two base stations of the calculated delay difference of each of the at least two base stations.

14. The gateway according to claim 13, wherein the processor is configured to:
transmit to each of the at least two base stations a first control packet including a time of transmission at which the first control packet is transmitted from the gateway;
receive from each of the at least two base stations a second control packet including a time of reception at which the first control packet is received by each of the at least two base stations; and
calculate a difference between the time of reception which is included in the second control packet and the time of transmission, thereby calculating a delay in information transmission between the gateway and each of the at least two base stations.

15. The gateway according to claim 14, wherein the processor sends the first control packet, transferred through multicast route, to each of the at least two base stations.

16. The gateway according to claim 14, wherein the processor sends the first control packet, transferred through unicast route, to each of the at least two base stations.

17. The gateway according to claim 13, wherein the processor is configured to:
receive from each of the at least two base stations a control packet including a time of transmission at which the control packet is sent from each of the at least two base stations; and
calculate a difference between the time of transmission which is included in the control packet and a time of reception of the control packet, thereby calculating a delay in information transmission between the gateway and each of the at least two base stations.
